(19) United States
(12) Patent Application Publication
(10) Pub. No.: US 2021/0016815 A1
(43) Pub. Date: Jan. 21, 2021

(54) ROLLER CART LUGGAGE

(71) Applicant: James S. Fleser, Piedmont, CA (US)

(72) Inventor: James S. Fleser, Piedmont, CA (US)

(21) Appl. No.: 16/932,760

(22) Filed: Jul. 18, 2020

Related U.S. Application Data
(60) Provisional application No. 62/876,303, filed on Jul. 19, 2019.

(51) Int. Cl. B62B 3/02; B62B 3/00; B62B 3/10; B62B 5/06; A45C 5/14; A45C 13/26; A45C 13/00

(52) U.S. Cl. CPC B62B 3/022; B62B 3/004; B62B 3/106; B62B 5/067; A45C 2013/267; A45C 13/262; A45C 13/001; B62B 2301/04; A45C 5/14

(57) ABSTRACT

Wheeled luggage characterized by its vertical orientation with the thin side of the bag aligned with the direction of travel and by its cart-like wheel configuration that has two fixed axis wheels near the retractable handle of the luggage and two spinning wheels at the other end. The retractable handle is offset allowing room for the legs when pushing the luggage as well as providing a location for a cupholder, tray for small items, etc. The top of the case's body contains a personal item catcher that deploys when the handle is extended and provides a place where medium-sized personal items such as a backpack, briefcase, large purse, etc. (which many travelers also take with them on trips), can be held in allowing for the bag to be stable at rest and while pushing the bag in a cart-like fashion during travels.

### CROSS-REFERENCE TO RELATED APPLICATIONS

This present application claims priority to and the benefit of U.S. Provisional Application Ser. No. 62/876,303 filed Jul. 19, 2019, the disclosure of which in incorporated herein in its entirety.

### FIELD

The present application relates to the structure and use of carry-on roller luggage.

### BACKGROUND

Carry-on roller luggage: It's an item almost all citizens of every first world country on the planet owns and many from lesser-developed parts of the world as well. From the elderly through teenagers and many children younger still, we all need to move around, and our roller bag is an essential belonging. And because of the wear and tear such an item endures on the road, most of us have to replace our luggage many times over the course of our lives. The overall luggage market worldwide is tremendous, estimated in 2015 to be in excess of $31B annually. And the carry-on roller bag is a large chunk of it.

However, the ubiquitous roller bag is not the only item we carry while we travel. Almost without exception, every one of us also carries other items as well. There is, of course, what the airlines like to call the “Personal Item” such as a purse, backpack, computer bag, etc. Maybe we also need to bring a coat to where we are headed. But we aren't done yet. We often buy items along the way as well, such as cups of coffee, bottles of water, bags of food, etc. Let's call these “Grab and Go Items.” Hauling all of these items can make getting around a hassle and it's something that almost every one of us struggles with.

Because there's practically no one who travels with a carry-on roller bag by itself, everyone creates a personal “system” to most conveniently move all of his or her belongings while traveling. Each personal system is influenced by our choice of carry-on roller bag type as well as the Personal Item we prefer. Grab-And-Go Items (like coffee or other drinks) are often simply accounted for as they are acquired. Current designs inadequately address the needs of the traveler with these additional items taken into consideration.

The carry-on roller luggage market is divided between two basic designs, the Two-Wheel bag and the Spinner design. Both feature a rectangular storage box, an extendable handle and some wheels to move the luggage around more easily than carrying.

The older of the two designs currently used is the “Two-Wheel.” The basic concept of the Two-Wheel bag has been leveraged for thousands of years. The traveler simply pulls the load behind him and it moves along the ground so it is not completely on the traveler's back as it would be if he simply carried it. But with modern Two-Wheel luggage 100 as shown in FIG. 1, instead of dragging the frame in a skidding fashion as humans have for thousands of years, there are wheels at of the bottom of the bag. It's a big improvement.

If you mention the words “Carry On” or “Roller Bag,” this is likely the type of luggage that comes to mind for most people. Its configuration consists of a pair of directional ‘in-line’ wheels (that are not casters and do not spin) and two projecting legs to keep it balanced when stationary as seen in FIG. 2. It is pulled behind the traveler and it moves with its wider profile side facing forward. FIG. 3 highlights these characteristics of this prior art.

It's a design that's fairly efficient, useful and its simplicity is evident. However, the Two-Wheel design still pulls downward on the hand a bit and it's dragged at a fairly unnatural place where the hand is rotated uncomfortably behind the user as portrayed in FIG. 2. Although the strain on the hand and arm are not too noticeable at first, more often than not travelers finds themselves changing hands often with the Two-Wheel design as fatigue sets in. But especially when used by itself, it's a great basic design.

The newer design of the two primary types of travel luggage is the “Spinner,” 200; as shown in FIG. 4. It is very similar in outward appearance to the Two-Wheel bag but instead of two primary directional wheels and two small stands, the Spinner has four swiveling wheels (casters) that all support the bag and are intended to all stay on the ground during use with no leaning. During use, it is off to the traveler's side (with a motion that can be mostly described as a “push” but can become “pull” if the bag lags behind, see FIG. 5; sometimes “side drag” is a good adjective when the surface is less than perfectly smooth) and the Spinner is oriented with its thinner side facing forward as illustrated in FIG. 6.

This Spinner 200 design has a few advantages over the Two-Wheel 100. The primary advantage of the Spinner carry-on is that the weight of the bag rests more on the wheels. And because the Spinner is pushed/pulled alongside the traveler instead of dragged behind, it's easier on the arm and hand. It's remarkably effective on hard, smooth surfaces such as tile, marble, etc. Perhaps the biggest drawback is that on any smooth surface that is other than perfectly level, the bag will roll downhill quite easily unless the user is holding it still and this can be cumbersome, as it requires constant attention of one hand.

However, when it hits rougher surfaces such as all but the smoothest pavement/concrete (such as practically all parking lots, sidewalks, curbs, etc.) or, heaven forbid, carpeting (as in plane aisles, hotel hallways, etc.), the Spinner 200 has a strong tendency to twist and keeping it by your side quickly becomes cumbersome, as shown in FIG. 7.

However, we don't have a complete picture. Besides the luggage, travelers more often than not carry other items necessary for their trip. As indicated earlier, there's hardly an individual that travels with the carry-on roller bag by itself. Bringing along a Personal Item (a favorite airline term) as well as “Grab And Go Items” (GAGI) is all but universal and the types of additional items that travel with us vary widely between each individual. Because we all travel with one or more of these additional items, it is absolutely essential that this fundamental fact of traveling finally be addressed as part of a next generation luggage system. Let's define what they are in more detail.

The Personal Item (PI): Almost all travelers also carry a personal item. Unlike the Carry On bag which is one of two typical designs, the type of PI can vary greatly from person to person. It can be anything from a computer bag, backpack, large purse, etc., so the form factor varies dramatically. It's a very individual choice, as are the items the Personal Item contains; computers, books, tablets, portable pillows, etc.

There is one thing that most of us would agree on and it's that we typically put more into our PI than we really need “just in case.” The result is that it can get heavy after a while. However, items packed in our other luggage, (such as the roller bags stored in the overhead bins), are not readily available from our seats. So, having things stored in our nearby PI is quite convenient.

Grab-And-Go Items (GAGI): But the Personal Item is not all we end up carrying around with us while we travel; yet we often don't consider these other items when considering our choice in luggage. Unless you strictly journey to and from very mild climates, we often bring along a jacket, scarf, hat, etc. Further, we also acquire additional items such as cups of coffee, bottles of water, bags of to-go food, etc. while we are on the move. If you've ever seen the line at an airport Starbucks, you know that traveling with a cup of coffee in your hand is extraordinarily common. Together, these GAGI add to our burden while traveling.

Given that there's practically no one who travels with a carry-on roller bag by itself, everyone creates a personal “system” to most conveniently move all of his or her belongings while traveling. Each personal system is influenced by our choice of carry-on roller bag type as well as the Personal Item we prefer. Grab-And-Go Items (like coffee or other drinks) are often simply accounted for as they are acquired.

Two-Wheel Roller Bag-Based Systems. Travelers leveraging a Two-Wheel bag often utilize one of these systems:

Carry & Drag: This system finds the user carrying the PI on their back while dragging the Two-Wheel bag behind them. This is a very typical scenario when a backpack is the PI of choice, however, purse and computer bag carriers often leverage it as well. (See FIG. 8)

It's quick and simple but the strain on the back can really start to cause discomfort and fatigue over time. Even when the traveler is standing still, (such as in the many lines encountered on our journeys), the PI continues to pull downwards on the spine. Taking the PI off to rest it upon the top of the carry-on luggage (and holding it there so it doesn't fall) is an option that many resort to. This turns into an all-day ordeal of taking the personal item on and off and holding onto the stacked pair of bags whenever stationary.

Top Load: In this scenario, the traveler rests their personal items on the extended handle of the Two-Wheel roller bag. Some luggage manufacturers even create features that better mate the two items by adding connectivity to the system. FIG. 1 is an example.

Though care is needed to make sure that the PI doesn't slip off the extended handle of the Two-Wheel bag, this is a quick and easy way to take the load off one's spine. However, not only does this technique add weight to the Two-Wheel bag, this added weight is placed higher up on the handles and this dramatically increases the hand fatigue due to the increased leverage. While this is even noticeable in stronger travelers, the strain on others (such as the elderly and children) can make it very difficult to utilize. This is illustrated in FIG. 9.

Another primary disadvantage of this Top Load system is again the “At Rest” positioning. When the traveler stops and puts the bag upright, the PI's position causes problems. If the PI isn't connected to the handles it can easily fall off. If the PI is in fact connected to the handles, (as some bag's designs facilitate), the bag has a tendency to tip because the PI is off-center to the Two-Wheel bag supporting it. While this issue is less of a problem for very small and thin personal items, many carry-on items (like computer bags and backpacks) can't be described as small and thin, thus increasing the leverage that causes tipping and/or the PI falling off. (See FIG. 10.)

The Pilot System: Consider for a moment airline pilots. Not only do they travel more in a week than many folks do in a year, they must bring along a lot of pilot-related materials (along with their roller luggage containing personal items such as clothes, hygienic supplies, etc.), so their Pilot Bag (their ‘Personal Item’) is quite heavy and cumbersome. Because the disadvantages of the Two-Wheel systems outlined above are so noticeable, pilots often leverage a third Two-Wheel system to overcome the load. Their pilot bag is positioned level with the bottom of the Two-Wheel roller bag and is attached to the top of the roller bag. Note the position of the pilot's PI in FIG. 11.)

Because the pilot's heavy PI isn't placed on the handles of the roller bag, it doesn't add to the fatiguing downward pull of the handle. Though its configuration does make it a little harder to put the combined bags into its ‘leaning’ position, it's a small price to pay. Though the pilot's bag does add significant weight to the overall load that needs to be pulled, this low location is a great solution for moving around. Even better, the ‘At Rest’ positioning is very stable as well because the PI doesn't need to balance atop the roller bag as it sits on the ground or floor. Some Two-Wheel roller bags of prior art design are equipped with a strap on the top of the luggage so that travelers can leverage this third Two-Wheel system themselves. However, any trip through an airport will reveal that normal travelers are rarely seen using this feature. Let's discuss why.

There are several drawbacks that make this promising technique actually the least used of the three Two-Wheel systems. First, the personal item is located at the bottom of the roller bag which means it comes into frequent contact with the ground or floor. While pilot's bags are often heavily reinforced and expected to get a bit dirty or scuffed up, this technique isn't really an option with the typical traveler's personal items (such as purses, computer bags, backpacks, etc.). Not only do most folks not want their PI being soiled by coming in frequent contact with dirty floors, parking lot concrete, etc., most also lack the durability to survive such abuse.

Further, backpacks, purses, computer bags, etc. almost universally have shoulder straps that would drag upon the ground and inevitably get tangled as well as filthy.

The pilot system also makes for a more stretched out and thus slightly more cumbersome load. And finally, the personal item is relatively far away from the traveler when using the pilot system and that prohibits quick access to the PI (such as grabbing a wallet or other item contained therein) and can feel like a security risk as personal items often contain our most valuable cargo. For these reasons, this system, (which is almost universally leveraged by the most frequent of flyers: pilots), is rarely used by the everyday traveler.

Spinner-Based Systems. Owners of most Spinner carry-on bags can leverage the first Two-Wheel systems outlined above (the ‘Carry & Drag’ and the ‘Top Load’) but the Spinner bag's design does not lend itself to the Pilot system. However, the Top Load system works a little differently when using a Spinner bag and thus let's define it as its own system.

Load & Push/Pull/Drag: This technique involves simply putting the personal item on top of the Spinner bag and pulling the two combined next to you. FIG. 4 shows such a system.

On very smooth surfaces, (such as marble, tile, linoleum and perhaps the rare patch of very smooth concrete), this is a very efficient system. However, the added weight of most personal items on the Spinner bag not only dramatically increases the inherent twisting motion that we covered earlier and outlined in FIG. 7, the extra weight also creates a tendency for the bag to fall behind the user as opposed to off to the side. This problem plagues the Spinner bag whenever travelers encounter a surface other than something ultra-smooth; which is all the time. The result is the effort to move the Spinner bag along can begin to be described as drag-along instead of pushing.

Further, the At-Rest positioning of this system suffers the same shortcomings of its Two-Wheel counterpart. Personal Items of any bulk at all will have their center of gravity offset to that of the bag, and a tipping hazard is created in the same manner discussed earlier and is illustrated in FIG. 12 from a Spinner perspective. And because of it uses four caster-type wheels, the Spinner will quickly roll downhill on any smooth surface that isn't level and the increased weight only exacerbates this tendency to resist an At-Rest at all.

The Wide Profile Traveler. Sometimes we can't see a problem if we've lived with it a long time and this may be one of those instances. The typical two roller bag designs and their corresponding travel systems that we outlined above all have one glaring problem in common. They create a very wide profile.

Moving Through Travel Space: Let's look at our traveling selves as portrayed in FIGS. 2 and 5.

Do you notice how wide we are? Now think about the fact that travel almost always means that we are moving in tight places with many other people. Most airport terminals, for example, are very cramped during peak hours, which seem to be all day. The moving sidewalks that have a “Stand on the Right, Walk on the Left” protocol are often not wide enough to facilitate this type of request because there isn't enough space to pass because of the wide profile.

With people moving at different speeds (some strolling while others need to run) and often in opposite directions, it's hard to move through a crowd efficiently with luggage, and the wide profile created by walking with the roller bag systems we use is a principal culprit. Now, let's consider the ultimate traveler's gauntlet: The Crowded Airplane Aisle.

Most airlines have made the aisles so narrow that it's near impossible to wheel a typical carry-on bag down to your seat. This is especially true upon boarding when people are already in the aisle seats that you need to pass on the way to your seat. Almost every single passenger jet in the world has carpet on the floor and that means trying to wheel a Spinner pushed out in front of you doesn't work and you can't drag a Two-Wheel behind you without taking off arms of several passengers. FIG. 13 portrays the issue with a Two-Wheel bag and FIG. 14 leverages a Spinner bag.

Many folks are forced to surrender and pick up their wheeled luggage, turn it sideways (so the profile is thinner with Two-Wheel bags) and just carry it down the aisle. This is cumbersome for even the fittest traveler and quite difficult for those less robust.

It would be desirable, therefore, to develop new methods and other new technologies for carry-on roller luggage, that overcomes these and other limitations of the prior art.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

A novel Roller Cart carry-on luggage 400 as shown in FIGS. 15-22 is more than just a piece of luggage. It facilitates a system for carrying what we travel with and allows for more efficiency for everyone while doing it. FIG. 15 shows a perspective view of the luggage 400 when opened for use (and highlighting its unique ‘Universal Personal Item Catcher’ at the top of the bag) while FIG. 16 portrays roller cart luggage 400 in a folded (collapsed) state that is leveraged while being stowed. FIGS. 17A and B show the luggage 400 in front and rear view respectively while closed. FIG. 18 shows the luggage 400 side view while closed. FIG. 19 is a side view with handle and PI Catcher extended/deployed and FIG. 20 pictures the same but demonstrates the luggage 400 in typical use with a back-pack (P1) on top in the Catcher and two ‘Grab and Go Items’ that consist of a food takeout bag hung on the hook and a coffee cup positioned in the tray's cup holder.

FIG. 21 is a perspective view of the luggage 400 in a deployed state with numerals highlighting its components. FIG. 22 is the same with the luggage 400 in its collapsed state.

The roller cart luggage invention is clearly novel when compared to the prior art. The most basic aspect of this novelty is the overall configuration of the Roller Cart. FIG. 25 illustrates the basic configuration and how it relates to direction of travel as we did with the Two-Wheel bag (in FIG. 3) and the Spinner bag (in FIG. 6). FIG. 27 shows the corresponding overhead usage view. Let's highlight the fundamental differences.

As described earlier, the Two-Wheel bag has a pair of directional in-line wheels along with two ‘stands’ for stationary balance and is meant to be used leaning with its wider side facing forwards while being pulled behind the traveler. (FIGS. 2 and 3 illustrate the usage configuration of the Two-Wheel design.) The leaning configuration causes strain on the hand but it does mean that the traveler's feet can move under the handle without kicking the bag.

The Spinner bag has four swiveling casters and is oriented with its thinner side facing forward while it's being pushed/pulled/side-dragged beside the traveler with all four wheels remaining on the ground/floor. (FIGS. 5 and 6 demonstrate the configuration.) Though it is oriented with the thinner side of the bag facing forwards, the usage model means the bag is held off to the side which, (like the Two-Wheel bag), provides for a wide profile. Further, during use the handle, (which is attached to the longer side of the bag as with the Two-Wheel bag), remains directly above the bag, which means that the traveler's feet cannot enter the space of the handle without kicking the bag and thus cannot be used directly in front of or behind the user without difficulty.

The novel roller cart 400 has two in-line wheels but, unlike the Two-Wheel bag, the wheels are located on the thinner side of the luggage so that the orientation is contrary to the Two-Wheel bag. The Roller Cart 400 also has two swiveling casters for front wheels and is intended to be used with all four wheels remaining on the ground like the Spinner bag, so there is no leaning necessary. But, in stark difference to the Spinner bag, the handle of the Roller Cart not only projects from the thin side of the bag, its final usage location is not directly above the bag but clear to the rear of the bag. Thus, the Roller Cart can be pushed (or pulled) directly in front of (or behind of) the user without being struck with the traveler's feet.

FIGS. 27 and 28 bring the three bags (prior art Two-Wheel bag 100, prior art Spinner bag 200 and invention Roller Cart 400) into side-by-side comparisons to more clearly highlight the contrast in design orientation and usage configuration.

The Roller Cart also has three other design features that are novel. First is a rear wheel locking mechanism as shown in FIG. 22 that prevents the cart from rolling down inclines like the Spinner bag. Second is the Liquids Quick Check that facilitates inspection of liquids at security checks Third is a Valet Stand access panel that presents a handy, upright display of traveling necessities when opened at the traveler's destination.

Benefits of the new Roller Cart carry-on luggage 400 may include:

Maneuverability and Smoother Ride: Because the bag leverages a cart-like wheel system, it is much easier to maneuver through obstacles. The spinning front wheels can be typical casters or, as disclosed here, they can leverage a unique design that allows for larger diameter wheels via a “Rakeless” caster mechanism as shown in FIGS. 23 and 24. Its utility and construction is described in greater detail in the Detailed Summary section that follows. Because the Rakeless caster allows for larger diameter wheels than traditional casters, (and it's rear in-line wheels are also inherently relatively larger than casters), all four wheels of the Roller Cart are much larger than traditional Spinner bags, therefore it pushes easily and has a much smoother roll; that in turn reduces hand fatigue during extended use.

Personal Item Facilitation: The Roller Cart luggage creates a system that provides for a methodology of efficiently traveling with the ubiquitous Personal Item that we all bring with us on our journeys. The universal “capture” mechanism on top of the bag provides the capability to securely hold a vast percentage of the myriad of potential Personal Items used by travelers. It also uses two unique types of bendable stabilization supports that won't easily break. See FIG. 21 as well as the Detailed Description below for greater detail.

At-Rest Stability: Unlike traditional roller bags, the capture mechanism on top of the Roller cart purposefully centers any additional load, (such as Personal Items that we carry with us while traveling like a backpack, computer bag, purse, etc.) so that its center of gravity is centered with that of the bag. FIG. 24 highlights this feature from a side view and a front view. Keeping the mutual center of gravities of both baggage and load aligned greatly reduces the tendency of a PI-on-Roller-Bag stack to tip. The feature facilitates the ability for the traveler to stop their walking motion at any time and have their belongings (Luggage, PI, GAGI, jacket, etc.) inherently in a stable position. Thus, no additional effort (such as taking off a backpack or holding a tippy baggage stack upright) is required by a traveler who comes to a pause while walking. Whenever the user of the novel roller cart stops their forward motion, they can comfortably stand with no need to hold a tippy baggage stack or have a bag hanging on their back, causing fatigue and/or pain of spinal compression.

Comfort & Less Fatigue: The novel roller cart described herein allows for use without having the baggage load placing any downward or twisting force on the user's hand. It also has its pushing handle positioned in a natural position in front of the user. Both characteristics clearly distinguish the roller cart from the prior art and greatly reduce strain and increase comfort for travelers. Two-Wheel bags force the user to have their hand behind them and twisted into an unnatural position (See FIG. 1). The Spinner bag, on the other hand, allows the user to have their hand more naturally positioned at the traveler's side but, (as described earlier), this only works on hard, smooth surfaces which only make up a portion of the traveler's environment (e.g., rough parking lots, hotel hallway and room carpeting, etc.). Also, (as also highlighted above) the larger wheels of the Roller Cart make it easier to push (or pull) and that adds up over time. Finally, one “pushes” the Roller Cart directly in front them, (instead of pulling like Two-Wheel bags or the “side drag” of Spinner bags), and this is an easier motion.

Thin Profile and Space Efficiency: Because its overall orientation (with its thin side facing forward and positioned directly in front of you), provides a thinner profile that makes the Roller Cart Luggage significantly easier to move through the continual maze created by the countless obstacles encountered in crowded terminals, planes, shuttles, etc. And not only is it beneficial for each individual traveler, the more people that adopt the novel Roller Cart, the more efficient we'll all be able to move because the cumulative impact of all the wide profile travelers really adds up.

Grab And Go Item Facilitation: The novel roller cart carry on has a platform that functions as a small, portable table. This table contains a cup holder for the nearly ubiquitous cup of coffee (or other beverage) most travelers carry. It can also be used as a portable table for light items such as a computer. Directly below the platform there is a hook from which users can hang moderately light items (e.g., takeout food, bottle of water, duty-free supplies, etc.).

Thin Profile: Because the bag is pushed in front of the user, (instead of off to the side), the traveler has a thinner profile that makes moving through spaces used by travelers, (such as airplane/train aisles, crowded hallways, parking lots, etc.), much easier for the user as well as more efficiently leverages the space shared with fellow travelers.

Liquids Quick Check: TSA requires that travelers store liquids (not to exceed three ounces) in a clear plastic bag and remove this bag for visual inspection during the security X-ray. The novel roller cart also allows the user to simply unzip the Quick Check flap and reveal a clear bag (made of plastic, vinyl or other clear material) with the traveler's liquids. No need to open the luggage or store the liquids bag in an outside pocket (which is a poor use of the allowed carry-on space). FIGS. 30 and 31 illustrate the feature.

Valet Stand Access Flap: This feature allows items stored in the pouches on the inside of the baggage access side to be vertically displayed for easy access once at the traveler's destination. FIGS. 32 and 33 demonstrate the concept.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the examples may be employed. Other advantages and novel features will become apparent from the following detailed description when considered in conjunction with the drawings and the disclosed examples, which encompass all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify like elements correspondingly throughout the specification and drawings.

FIG. 1 is a perspective view illustrating a prior art Two-Wheel roller bag 100 in use.

FIG. 2 is an overhead view of the prior art Two-Wheel roller bag 100 in use to establish the use configuration of the design.

FIG. 3 consists of a side view as well as an overhead view that further illustrates the use configuration of the prior art Two-Wheel luggage 100 for contrast to invention.

FIG. 4 is perspective view illustrating a prior art Spinner luggage 200 in use.

FIG. 5 is an overhead view of the prior art Spinner roller bag 200 in use to establish the use configuration of the design.

FIG. 6 consists of a side view as well as an overhead view that further illustrates the use configuration of the prior art Spinner luggage 200 for contrast to invention.

FIG. 7 is a diagram illustrating the undesirable twisting motion of the prior art Spinner luggage 200 that causes hand fatigue during use.

FIG. 8 is a perspective view illustrating a prior art Two-Wheel roller bag 100 in use with another piece of baggage (a backpack) to define the “Carry & Drag System” for combined use.

FIG. 9 is a side view illustrating the ‘downward pressure on hand/arm’ drawback of using prior art Two Wheel luggage 100 in a “Top Load System” when used with another smaller piece of luggage typically used by travelers (i.e., a Personal Item).

FIG. 10 is a side view illustrating the ‘tipping’ drawback of prior art Two Wheel luggage 100 when used with a PI bag while using the “Top Load System.”

FIG. 11 is a perspective view of prior art Pilot Bag 300 in the Pilot system.

FIG. 12 is a side view illustrating the ‘tipping’ drawback of prior art Spinner luggage 200 when used with a Personal Item when using the “Top Load System.”

FIG. 13 is an overhead view illustrating the ‘wide profile’ drawback of prior art Two Wheel luggage 100 when attempting to navigate a narrow aisle.

FIG. 14 is an overhead view illustrating the ‘wide profile’ drawback of prior art Spinner luggage 200 when attempting to navigate a narrow aisle.

FIG. 15 is a perspective view illustrating aspects of the novel Roller Cart luggage 400, in an unfolded state.

FIG. 16 is a perspective view illustrating aspects of the novel Roller Cart luggage 400, in a collapsed state.

FIG. 17 is a side view illustrating aspects of the novel Roller Cart luggage 400, in a collapsed state

FIG. 18 is a side view illustrating aspects of the novel Roller Cart luggage 400, in a collapsed state

FIG. 19 is a side view illustrating aspects of the novel Roller Cart luggage 400, in an unfolded state.

FIG. 20 is a side view illustrating aspects of the novel Roller Cart luggage 400, in an unfolded state and in use as a ‘system’ with a Personal Item (a backpack) captured by the Universal PI Catcher 450, a drink in the Grab-and-Go Table Tray 490 and a to-go food bag on the Grab-and-Go hook 495.

FIG. 21 is a prospective view of the Roller Cart in the deployed mode with labels of components. 1) The main body of the bag; 2) Table tray; 3) cup holder(s) and slot for top carrying handle; 4) supports for handle and tray; 5) rear in-line wheels (directional); 6) front swivel caster wheels; 7) Bendable support for universal “catcher” functionality; 8) Upper catcher ring (stretchable); 9) Lower catchier straps (not stretchable) that assist in tightening the supports onto the personal item while catcher is in use and folds down the bendable supports upon stowage; 10) Liquids ‘quick check’ zippered access flap; 11) Zippered “valet stand” bag side and access to inner compartment; 12) Hanging hook for ‘grab and go items;’ 13) Pushing handle during use; 14) Front carrying handle; 15) Top carrying handle; 16) Support for table and upper catcher ring.

FIG. 22 is a prospective view of the roller cart in the stowage mode with labels of components. 1) The main body of the bag; 2) Table tray; 3) cup holder(s) and slot for top carrying handle; 5) rear in-line wheels (directional); 6) front swivel caster wheels; 10) Liquids ‘quick check’ zippered access flap; 11) Zippered “valet stand” bag side and access to inner compartment; 13) Pushing handle during use; 14) Front carrying handle; 15) Top carrying handle.

FIG. 23 is a progression of side views illustrating aspects of how the novel roller cart luggage unfolds and deploys for use.

FIG. 24 highlights the dramatic reduction in potential tipping of stacked baggage (Personal Item on top of roller bag) provided by the novel Roller Cart's Universal PI Catcher due to its ability to align the center of gravity of the Roller Cart and the Personal Item.

FIG. 25 is an overhead view of the prior art Spinner roller bag 200 in use to establish the use configuration of the design for contrast to prior art.

FIG. 26 consists of a side view as well as an overhead view that further illustrates the use configuration of the roller cart for contrast to prior art.

FIG. 27 is overhead usage configuration views of the prior art (Two-Wheel 100 and Spinner 200) and the Roller Cart 400 bag for easier direct comparison.

FIG. 28 consists of side views as well as overhead views of the prior art (Two-Wheel 100 and Spinner 200) and the Roller Cart 400 bag together in a single diagram that further illustrates the significant differences in configuration of the roller cart when contrasted to prior art.

FIGS. 29A-C show a diagram for a “Rakeless” caster that would provide for a smoother, more stable ride for the novel Roller Cart. 1) Hemispheric Caster Housing; 2) Axle; 3) Axle Plate; 4) Wheel; 5) Light spring return; 6) Ball bearings.

FIG. 30 contrasts the Rakeless caster 500 with prior art caster 499 where 90 is the available space for a wheel, 91 is the diameter of the prior art caster wheel that fits within the space represented by 90. And 92 is the much larger diameter of a wheel when leveraging the Rakeless design.

FIG. 31 is a perspective view of the Liquid Quick Check flap.

FIG. 32 is a side view of the Liquid Quick Check flap.

FIG. 33 is a perspective view of the Valet Stand access flap with 17) distance restricting catch (also called a support member) made of durable material (cord, plastic, metal, etc.).

FIG. 34 is a side view of the Valet Stand access flap with 17) distance-restricting catch made of durable material (cord, plastic, metal, etc.).

FIG. 35 shows views of the bendable supports used for restraint components of the Universal Personal Item Catcher. Consisting of: 80) A shaft; (round, rectangular, triangular, etc.) made of firm material (wood, plastic, etc.) to maintain an upright support and have flexibility with either no directional preference (round) or with directional preference (multi-sided); It can be two or more pieces; 81) Stretchable material (rubber, elastic, etc.) that is attached to the assembled stack of shaft while the material is stretched; The material can be strong or light depending on the desired preference for upright tension and directional preference; 62) Attach points (staples, glue, etc.) that maintain tension and keep stretch material centered. Can be closer or farther from shaft piece joins depending on application.

FIG. 36 is a cut-away view highlighting one of the potentially many ways the novel Roller Cart can be configured to operate with the focus on the components that enable its transition from stowed/collapsed state to deployed state with Universal Personal Items Catcher extended and table tray with cup holder in position near the push handle. 2) Table tray; 4) supports for handle and tray; 7) Bendable support for universal “catcher” functionality; 8) Upper catcher ring (stretchable); 9) Lower catchier straps (not stretchable) that assist in tightening the supports onto the personal item while catcher is in use and folds down the bendable supports upon stowage; 16) Support for table and upper catcher ring; 18) attached ends of lower catcher straps' 19) fulcrum for rotation that allows the supports for handle and tray to rotate into the proper position behind the roller cart while the support for table and upper catcher ring remain vertical.

FIG. 37 is a progression of cutaway side views illustrating aspects of one manner the novel Roller Cart luggage 400 could be engineered to unfold and deploy for use.

FIG. 38 is an overhead view illustrating the ‘thin profile’ advantage of the Roller Cart luggage 400 when attempting to navigate a narrow aisle.

FIG. 39 is an overhead view contrasting the profiles of the Roller Cart luggage 400, Two-Wheel bag 100 and Spinner bag 200 when attempting to navigate a narrow aisle.

FIG. 40 is a perspective view illustrating an alternative use of the carry tray.

FIGS. 41A-C are schematic diagrams illustrating various options for a mechanism to stow and unfold the main push handle.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

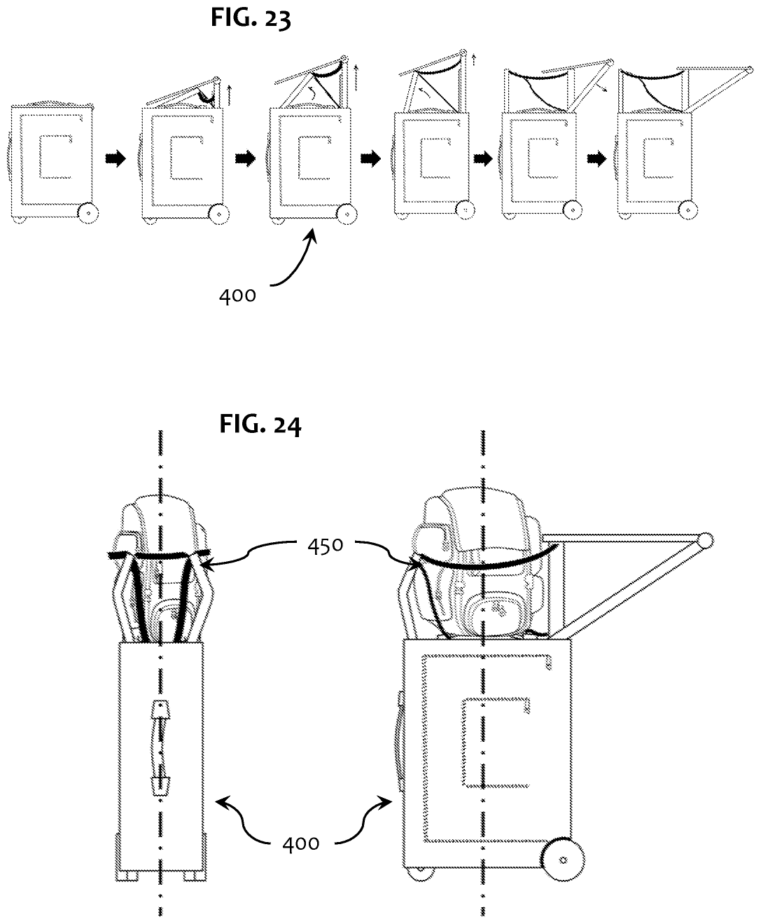

The new luggage provides several features that when combined, provide for a completely new travel experience. Let's look at how it opens up and we'll start to see the difference immediately. Referring to FIG. 23, a progression of images illustrates how the unfolding/deploying of the Roller Cart carry-on luggage 400. Folding is the reverse of unfolding.

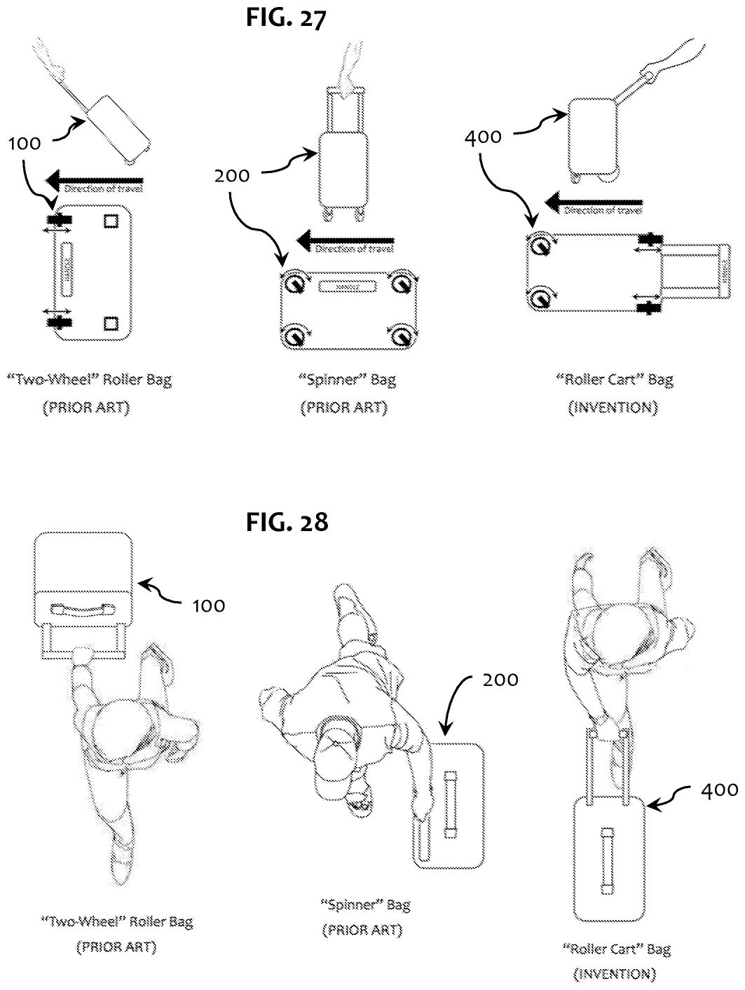

The retractable handle (long a staple feature of carry on luggage) is uniquely located on the thinner side of the bag as shown in FIG. 26. When extended, instead of sticking straight up and down like both the Two-Wheel 100 and Spinner 200 luggage, it folds/rotates downward behind the bag so that all four wheels stay on the ground while rolling and the handle is located behind the bag making it operate much like a grocery cart. FIG. 27 contrasts the handle orientation of the two prior art bags with that of the Roller Cart carry-on 400.

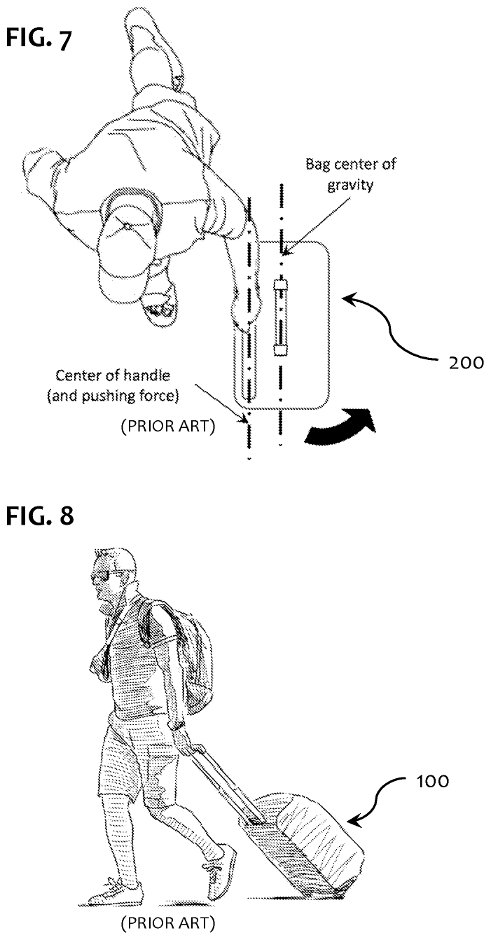

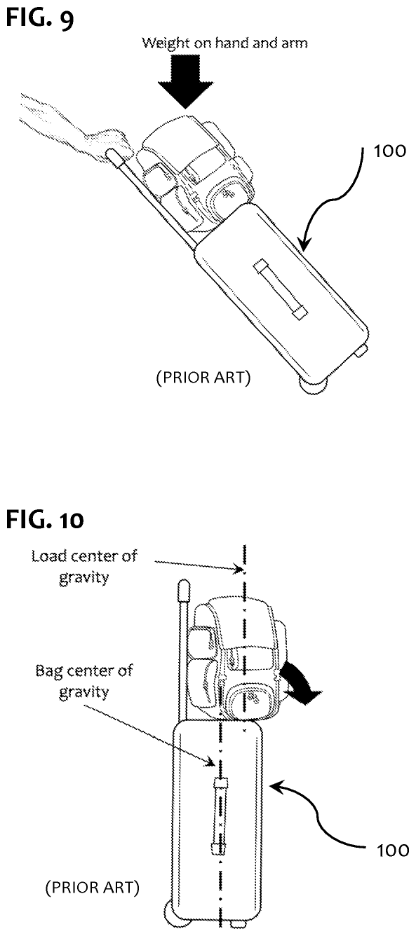

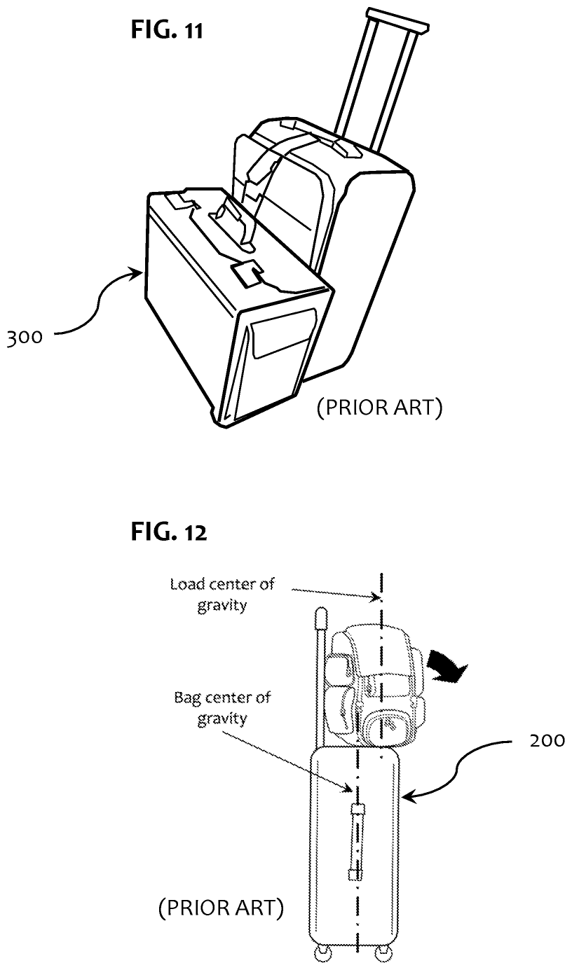

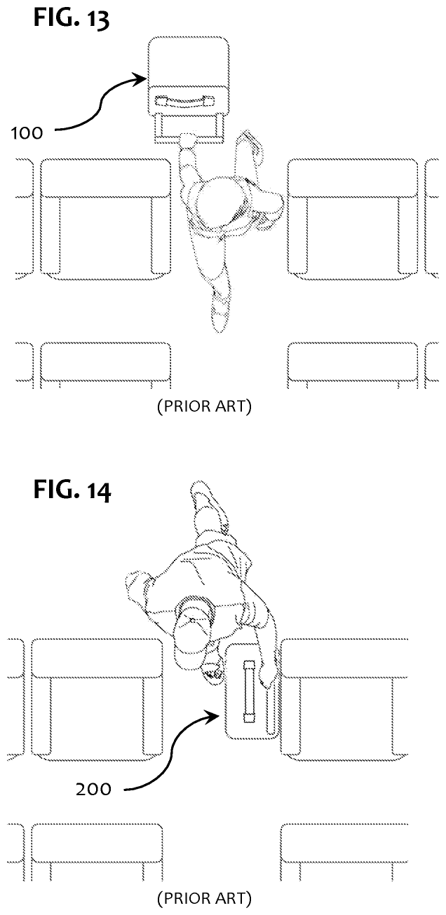

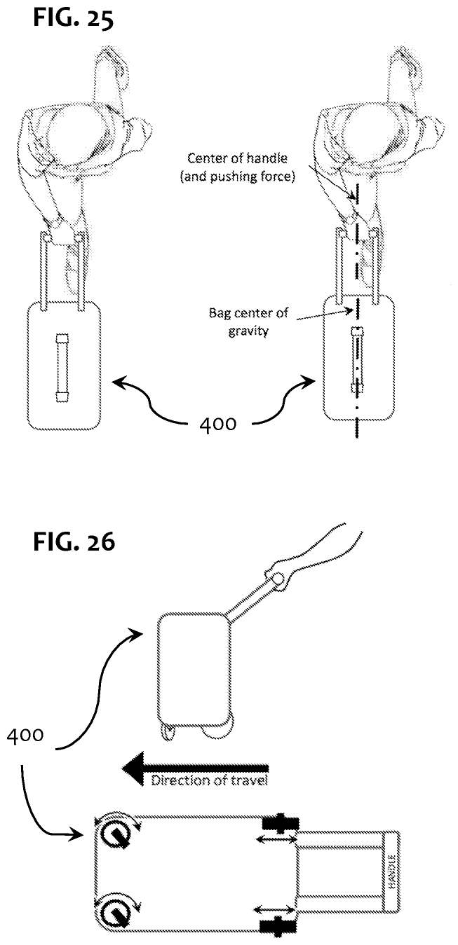

Unlike the typical Spinner carry-on 200, (that also has all four wheels on the ground while in use), the force vector being applied to the pushing handle of the Roller Cart (from the traveler's hand) is centered with the bag's center of gravity and thus there is no twisting motion (as depicted in FIG. 7 for the Spinner bag 200) no matter how rough the pavement or deep the carpet. FIG. 25 highlights this centered alignment in the Roller Cart 400. This unique configuration also places the handle of the Roller Cart 400 directly in front of the user's body, a very natural and comfortable position. Together, these two aspects dramatically reduce user fatigue and provide for a more maneuverable bag.

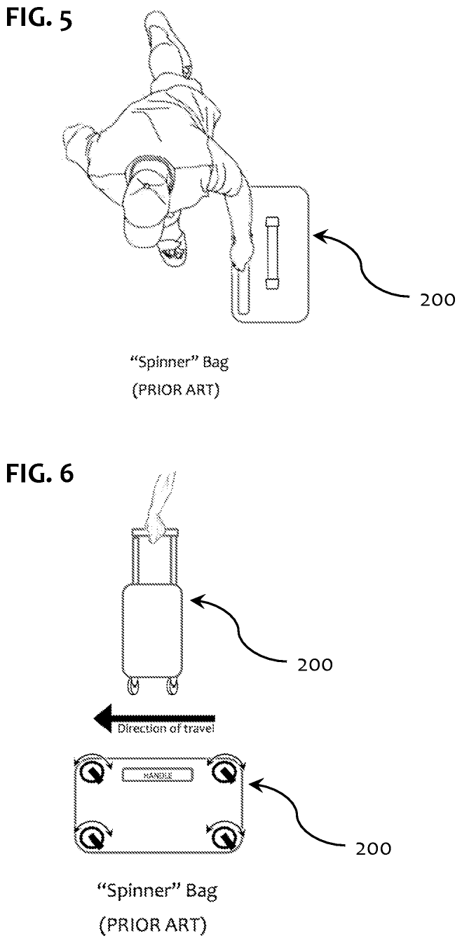

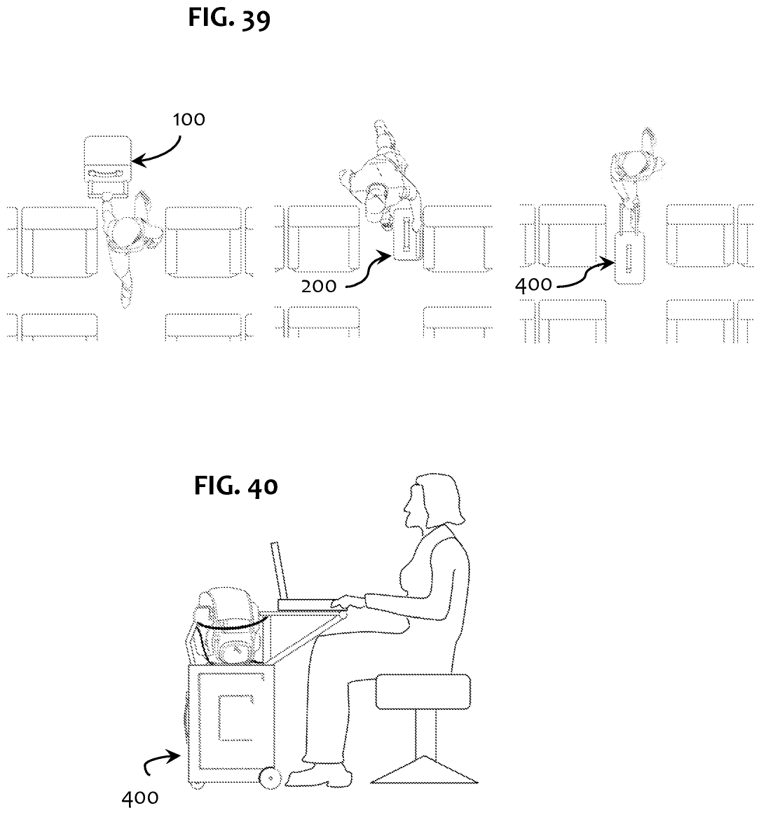

Further, the bag's unique orientation is that it presents a much thinner overall traveler profile. Instead of being held uncomfortably off to the side, the traveler can push the bag directly in front of them without danger of colliding with their feet due to the handle's forward offset. Compare the width of the profile of the novel Roller Cart 400 (FIG. 25) with the other two most common types using FIG. 2 (Two-Wheel 100) and FIG. 5 (Spinner 200). FIG. 39 contrasts the three styles while in use in a narrow airplane aisle. Note that in FIG. 39 the Spinner bag 200 is rotated so that the bulk of the bag is closer to the user than the typical usage configuration (that has the handle closer to the traveler's body as in FIG. 5). This alternate usage configuration of the Spinner 200 bag is adopted by travelers to partially address the issue of the wide profile. However, as you'll see, this brings the bag too close to the user's feet and the traveler has to bend forward in an attempt to reduce the profile further and keep from kicking the bag. This is uncomfortable and inefficient. And, because airplane aisles are typically carpeted, the spinning tendency (as highlighted in FIG. 7) is pronounced. If the traveler tries to have a Personal Item atop the Spinner bag at this juncture, it's almost impossible to push the Spinner bag well out in front of them under these circumstances.

The Roller Cart has two stationary, forward facing wheels in the rear and two rotating wheels (or casters) in the front; again, like a grocery cart. This makes it much more maneuverable than other luggage. This maneuverability is enhanced by the bag's thin profile as outlined above.

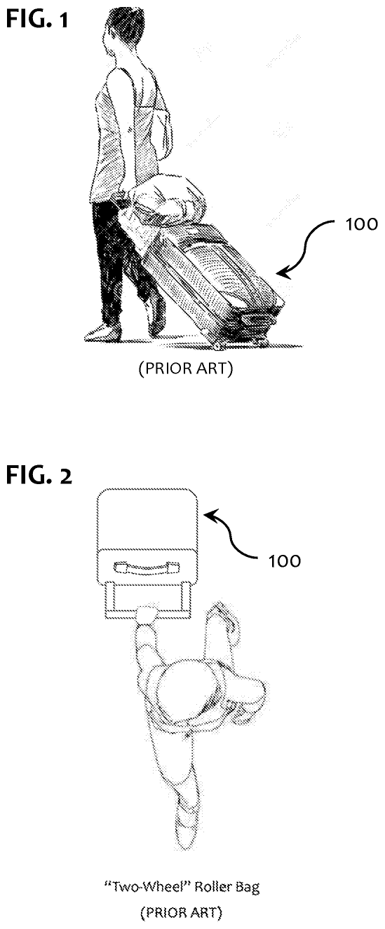

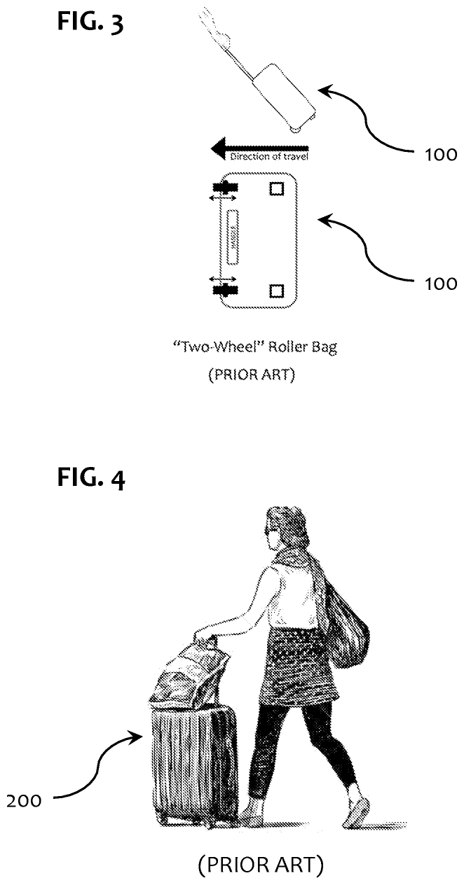

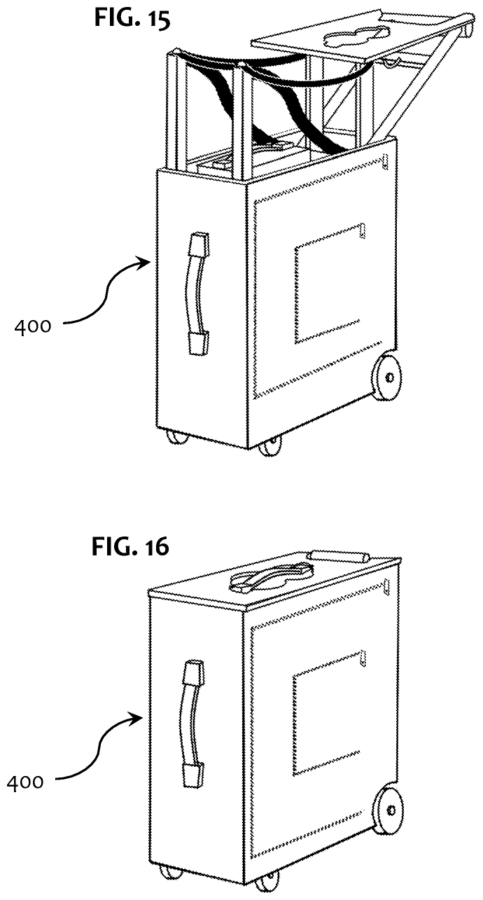

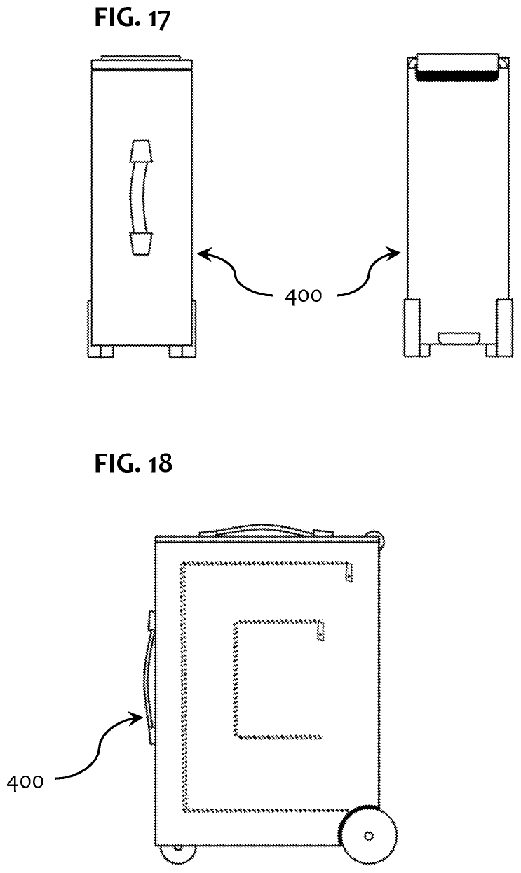

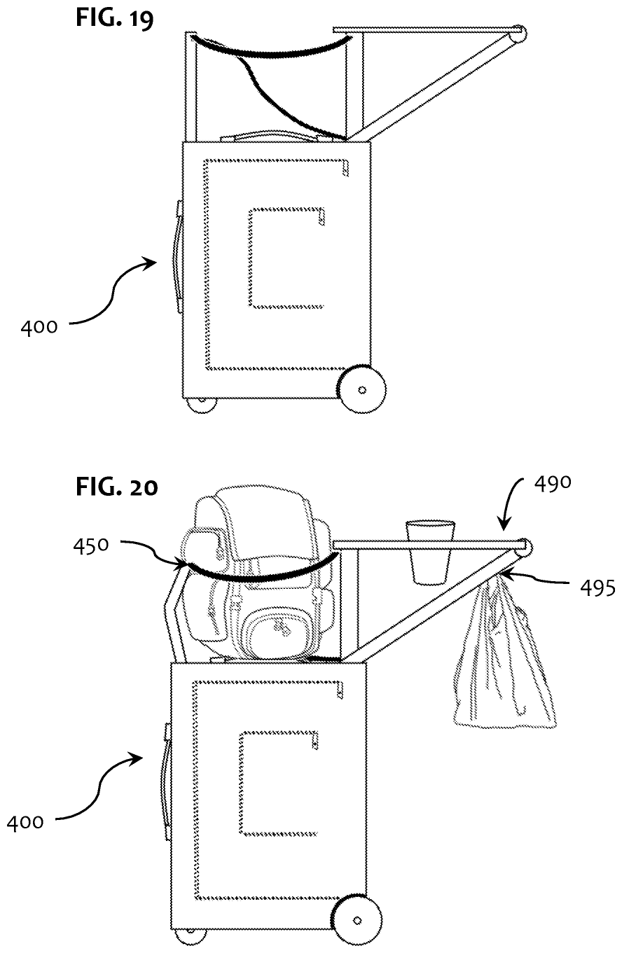

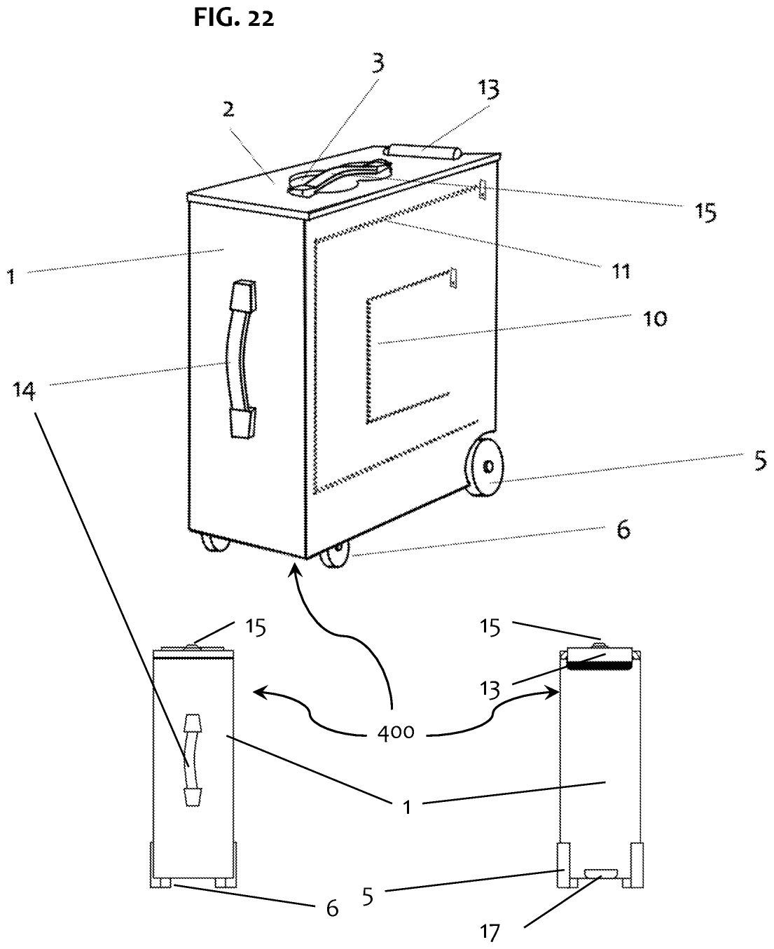

Further, as shown in FIGS. 15-26, the wheels of the novel Roller Cart 400 are much larger than on a typical Spinner bag 200 and the result is an easier piece of luggage to push and a smoother ride that further reduces effort and fatigue. This is especially true on surfaces that aren't perfectly smooth, flat and hard; which are a large percentage of those encountered by travelers. Small and moderately-sized bumps, (such as a transition between carpet and tile), are also significantly easier to traverse with the wheels and configuration of the Roller Cart. Though some Two-Wheel 100 bags have rear wheels that are relatively larger than others (especially than the casters found on typical Spinner 200 bags (see FIGS. 1, 4 and 8), the force on the arm caused by the Two-Wheel bag's ‘leaning’ use configuration means that these potentially larger in-line wheels don't make for less effort.

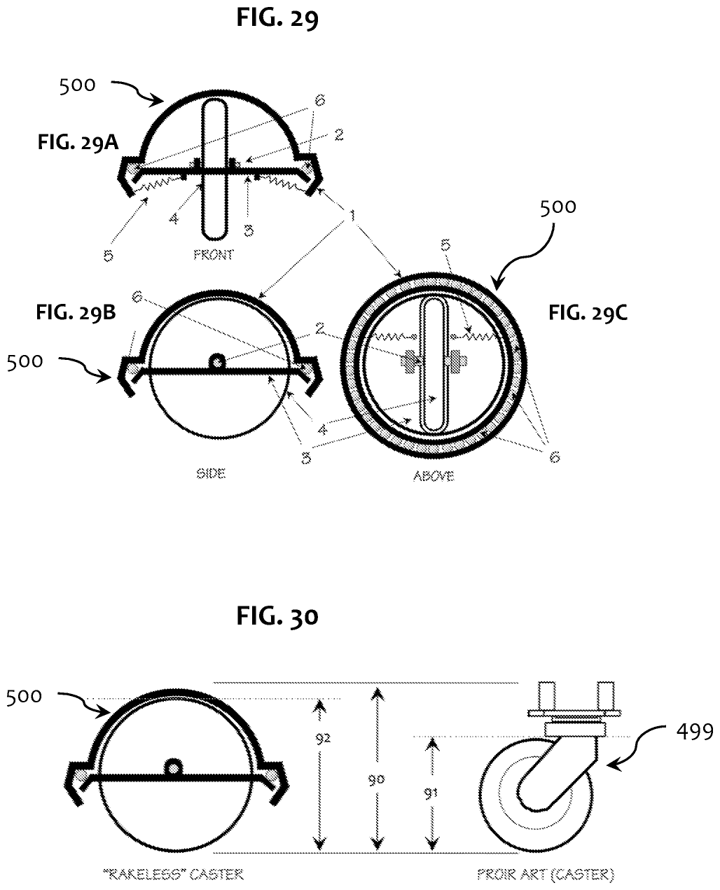

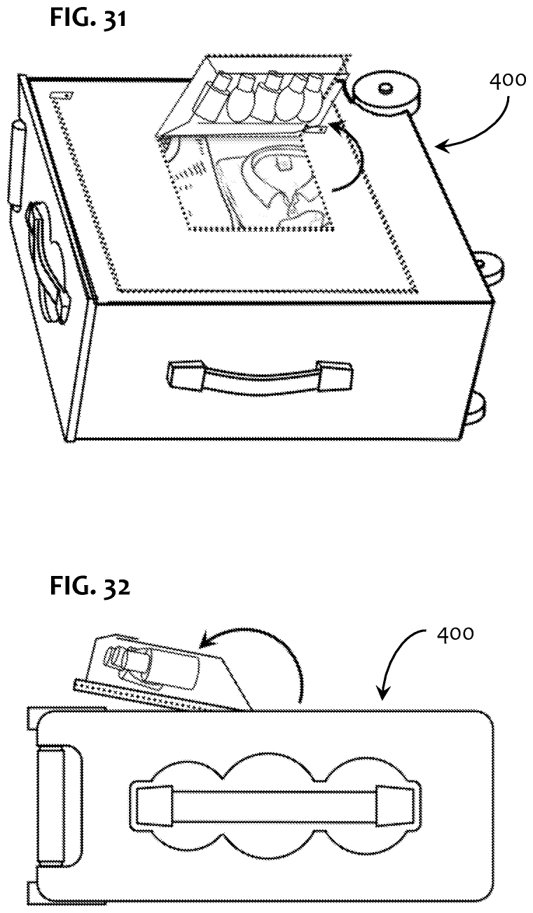

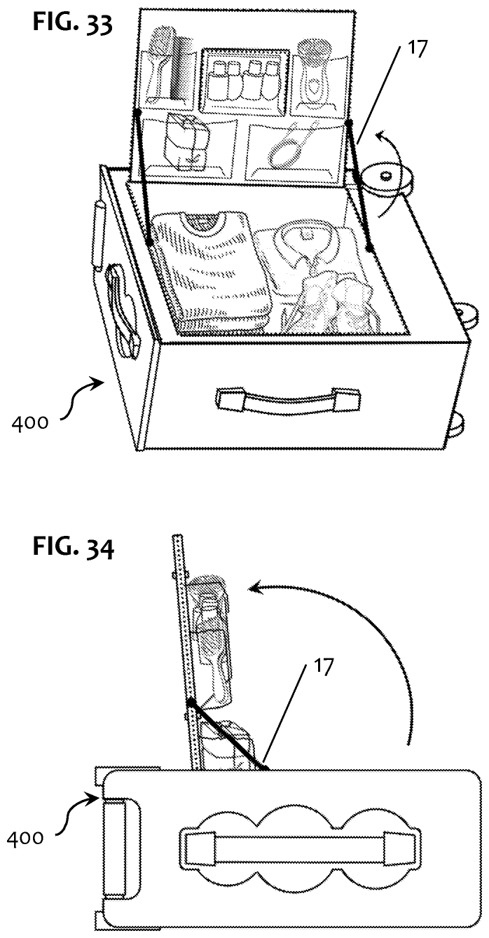

Though the Roller Cart could use typical casters 499 for front wheels, it also can leverage unique “rakeless” casters 500 also shown in FIGS. 29A-C and 30. It allows the caster to have a much larger wheel size in the given area (between the bottom of the bag and the floor/ground) to make for a significantly smoother ride.

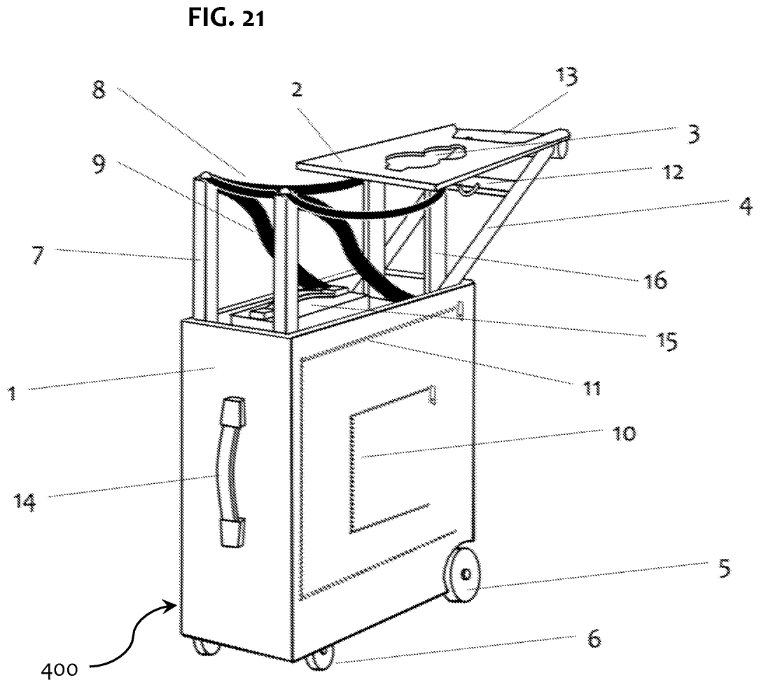

Perhaps the most immediately recognizable visual difference the novel Roller Cart 400 has is the ‘Universal Personal Item Catcher’ that provides a ‘system’ which takes into account the ubiquitous other items that everyone travels with. FIGS. 20 and 24 show the Roller Cart luggage 400 in use with the catcher 450. When combined with the table tray (labeled 2 in FIG. 21) and its associated cup holders 2, the intended system is clear and its advantages quite evident.

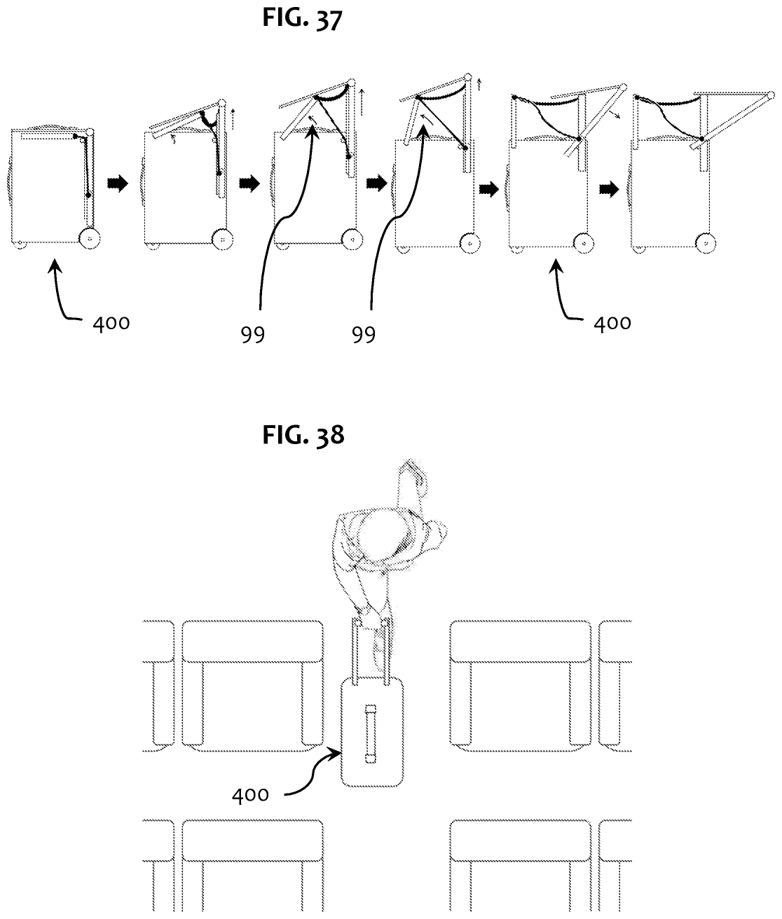

At first glance, it might be easy to assume that the front supports of the PI Catcher would be too fragile to withstand the rigors of travel. However, they are engineered to be extremely flexible and thus very durable. Not only does this “bend instead of break” design provide protection against failure, the bendable supports also facilitate the Roller Cart's ability to secure a wide variety of personal items. Finally, the elastic nature of the bendable supports provides for the spring-like action required for deployment. The upward pull of the supports is what provides the spring action as depicted by arrow 99 in FIG. 37.

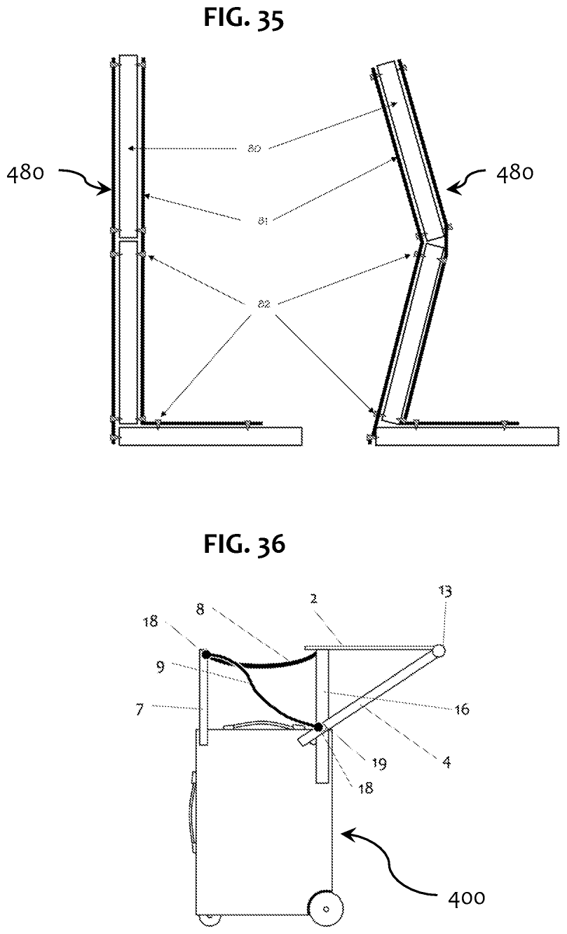

FIG. 35 show views of bendable supports 480 used for restraint components of the personal item catcher. As indicated, the flexibility of the personal item catcher provides a different kind of durability in that it can absorb twists, blows, pulls, etc. that would fracture rigid supports. The catcher is designed to be easily deployed and folded back into the luggage via smooth operation of the handle as depicted in FIGS. 23 and 37.

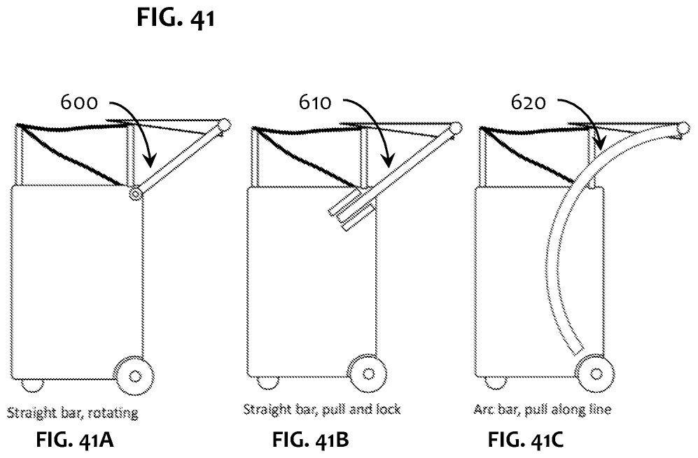

The other feature that lends to the Roller Cart baggage 400 singular appearance is the Grab-and-Go Items tray 490 (in FIG. 20) that is suspended between the pushing handle and personal item catcher. It can consist of a cup holder (or several of varying sizes) and/or small trays. The example highlighted in this document is a cup holder. It also serves as a small table that can be used for purposes such as holding a computer or tablet during periods of travel that find you waiting around either standing or sitting. FIGS. 41A-C illustrate use of the tray 490 as a computer desk. The Grab-and-Go Hook 495 is less noticeable when unused due to its location but when leveraged it can free up a traveler's hand.

The mechanism for unfolding the handle and other parts of the personal item carrier 450 may vary. FIGS. 41A-C illustrate various options for a mechanism to stow and unfold the main push handle. FIG. 15A illustrates a mechanism 600 wherein the handle is pushed in a linear motion through sliding restraints. FIG. 15B illustrates a mechanism 610 wherein a bar formed into an arc is pulled along a line. FIG. 15C illustrates a mechanism 620 wherein a straight bar is rotated around a pivot axis.

The previous description of the disclosed aspects is provided to enable any person skilled in the art to make or use the present disclosure. Various modifications to these aspects will be clear to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A roller carry-on luggage cart comprising:
a primary luggage compartment enclosed by a fabric, metallic, or plastic covering;
one or more rear wheels fixed to a single axis of rotation mounted at a lower rear of the primary luggage compartment;
one or more swiveling casters able to rotate around a vertical axis mounted at a lower front of the primary luggage compartment; and
a retractable handle coupled to the primary luggage compartment and configured to facilitate pushing the primary luggage compartment from the rear.

2. The apparatus of claim 1, further comprising a collapsible personal item carrier mounted at an upper portion of the primary luggage compartment and configured for restraining loose items placed on top thereof.

3. The apparatus of claim 2, further comprising a tray extending from an upper portion of the primary luggage compartment towards the handle.

4. The apparatus of claim 3, further comprising a hook beneath the handle.

5. The apparatus of claim 3, further comprising a cup holder formed in the tray.

6. The apparatus of claim 2, wherein the collapsible personal item carrier comprises a collapsible fence around at least a portion of a perimeter of an uppermost surface of the primary luggage compartment.

7. The apparatus of claim 6, wherein the collapsible fence comprises foldable supports supporting a resilient ring around an upper portion of the supports.

8. The apparatus of claim 7, wherein the foldable supports comprise rigid members coupled by bands of resilient material.

9. The apparatus of claim 1, wherein the one or more swiveling casters comprises a wheel coupled to an axle, wherein the axle is supported by a ring bearing encompassing the wheel around its diameter and permitting rotation of the axle around the vertical axis.

10. The apparatus of claim 9, wherein the ring bearing is coplanar with the axle.

11. The apparatus of claim 1, wherein the primary luggage compartment is configured as a generally rectangular prism.

12. The apparatus of claim 11, wherein the primary luggage compartment extends between a lowermost wall adjacent to the rear wheels and swiveling casters and an uppermost wall.

13. The apparatus of claim 12, wherein the primary luggage compartment is characterized by a generally rectangular cross-section between its lowermost wall and uppermost wall, having a greater dimension and a lesser dimension.

14. The apparatus of claim 12, wherein the retractable handle is configured for pushing the apparatus in a direction perpendicular to the lesser dimension of the primary luggage compartment.

15. The apparatus of claim 1, further comprising a handle coupled to an uppermost wall of the primary luggage compartment for lifting the apparatus when the retractable handle is retracted.

16. The apparatus of claim 1, further comprising a handle coupled to a longest and narrowest wall of the primary luggage compartment for lifting the apparatus when the retractable handle is retracted.

17. The apparatus of claim 1, further comprising a liquids compartment coupled to an interior of a side wall of the primary luggage compartment accessible from an exterior of the primary luggage compartment via a small zippered flap.

18. The apparatus of claim 17, further comprising a valet stand zippered flap in which the small zippered flap is formed, the valet stand zippered flap configured for accessing an interior of the primary luggage compartment.

19. The apparatus of claim 18, further comprising a plurality of compartments including the liquids compartment coupled to an interior surface of the valet stand zippered flap.

20. The apparatus of claim 19, further comprising a support member interposed between the valet stand zippered flap and sidewalls of the primary luggage compartment, the support member configured for holding the valet stand zippered flap in an open position.
